(19) United States
(12) Patent Application Publication
(10) Pub. No.: US 2023/0221979 A1
(43) Pub. Date: Jul. 13, 2023

(54) INFORMATION PROCESSING DEVICE, VEHICLE, INFORMATION PROCESSING METHOD, RECORDING MEDIUM RECORDED WITH INFORMATION PROCESSING PROGRAM

(71) Applicant: TOYOTA JIDOSHA KABUSHIKI KAISHA, Toyota-shi (JP)

(72) Inventor: Taiki MIZUTANI, Nisshin-shi (JP)

(21) Appl. No.: 18/060,018

(22) Filed: Nov. 30, 2022

(30) Foreign Application Priority Data
Jan. 13, 2022 (JP) 2022-003708

(51) Int. Cl. G06F 9/455; B60R 16/023

(52) U.S. Cl. CPC G06F 9/45558; B60R 16/0231; G06F 2009/45575; G06F 2009/45579

(57) ABSTRACT

An information processing device including a storage section and a control section. The storage section is configured to store startup condition information determined for each of plural virtual machines and including a startup condition related to a confirmation result of processing status of a processing execution section that performs processing related to the virtual machine or a startup condition related to a startup status of another virtual machine. The control section is configured to startup the virtual machine that has satisfied the startup condition based on the startup condition information.

### CROSS-REFERENCE TO RELATED APPLICATION

This application is based on and claims priority under 35 USC 119 from Japanese Patent Application No. 2022-003708 filed on Jan. 13, 2022, the disclosure of which is incorporated by reference herein.

### BACKGROUND

### Technical Field

The present disclosure relates to an information processing device applicable to an onboard system, a vehicle, an information processing method, and an information processing program.

### Related Art

A startup method for application startup in plural virtual machines is proposed in Japanese National-Phase Publication No. 2018-517948. More specifically this startup method includes receiving a startup command from a first virtual machine to startup an application on a second virtual machine and acquiring startup information corresponding to the startup command. The startup information includes information about the second virtual machine and information about the second virtual machine applications, and the second virtual machine is started up according to the second virtual machine information, and applications on the second virtual machine are started according to the second virtual machine application information.

There is room for improvement for a system including plural virtual machines, such as an onboard system, since startup needs to be performed with startup conditions that are individual for each of the virtual machines.

### SUMMARY

In consideration of the above circumstances, an object of the present disclosure is to provide an information processing device capable of starting up individual virtual machines each with appropriate startup conditions, and to a vehicle, an information processing method, and an information processing program of the same.

A first aspect is an information processing device including a storage section and a control section. The storage section is configured to store startup condition information determined for each virtual machine of plural virtual machines and including a startup condition related to a confirmation result of processing status of a processing execution section that performs processing related to the virtual machine or including a startup condition related to a startup status of another virtual machine. The control section is configured to startup a virtual machine that has satisfied the startup condition based on the startup condition information

In the information processing device of the first aspect the control section starts up the virtual machine that has satisfied the startup condition based on the startup condition information. The startup condition information is determined for each of the plural virtual machines and includes the startup condition related to the confirmation result of processing status of the processing execution section that performs processing related to the virtual machine or the startup condition related to the startup status of the other virtual machine. The “startup condition related to the confirmation result of processing status of the processing execution section” is, for example, confirmation that processing of the processing execution section has been completed. The “startup condition related to the startup status of the other virtual machine” is, for example, that another virtual machine having an inter-dependency relationship with the target virtual machine has been started up. This thereby enables startup conditions determined for each of the virtual machines to be set according to the processing execution section and the other virtual machine. Thus the individual virtual machines can each be started up with appropriate startup conditions.

An information processing device of a second aspect is the information processing device of the first aspect wherein the startup condition information determined for each virtual machine of the plurality of virtual machines includes at least one startup condition selected from the group consisting of a startup condition related to external interrupt, the startup condition related to the confirmation result of the processing status, and the startup condition related to the startup status of the other virtual machine, and the control section is configured to start up a virtual machine that has satisfied all of the at least one startup condition.

In the information processing device of the second aspect the startup condition information determined for each of the virtual machines includes at least one startup condition selected from the group consisting of the startup condition related to external interrupt, the startup condition related to the confirmation result of the processing status, and the startup condition related to the startup status of the other virtual machine. The control section starts up the virtual machine that has satisfied all of the at least one startup condition. The “startup conditions related to external interrupt” is, for example, that the power state has changed to ON. This thereby enables a combination of at least one startup condition to be set for each of the virtual machines.

The information processing device of a third aspect is the information processing device of the first aspect or the second aspect wherein the other virtual machine is a virtual machine that manages the plurality of virtual machines.

The information processing device of the third aspect enables setting of a startup condition related to the startup status of a virtual machine that manages the virtual machines.

The information processing device of a fourth aspect is the information processing device of any one of the first aspect to the third aspect wherein an update of the startup condition information stored in the storage section is performed prior to processing of the processing execution section.

A fifth aspect is a vehicle equipped with the information processing device of any one of the first aspect to the fourth aspect.

In the vehicle of the fifth aspect the control section starts up the virtual machine that has satisfied the startup condition based on the startup condition information. Thus in order to generate various virtual machines the information processing device installed in the vehicle is able to start up each of the various virtual machines with individual appropriate startup conditions.

A sixth aspect is an information processing method including an information processing device, which includes a storage section configured to store startup condition information determined for each virtual machine of plural virtual machines and including a startup condition related to a confirmation result of processing status of a processing execution section that performs processing related to the virtual machine or including a startup condition related to a startup status of another virtual machine, starting up a virtual machine that has satisfied the startup condition based on the startup condition information.

In the information processing method of the sixth aspect the information processing device starts up the virtual machine that has satisfied the startup condition based on the startup condition information. This thereby enables each of the individual virtual machines to be started up with appropriate startup conditions.

A seventh aspect is a non-transitory recording medium stored with a program that is executable by a computer to perform processing. The computer includes a storage section configured to store startup condition information determined for each virtual machine of plural virtual machines and including a startup condition related to a confirmation result of processing status of a processing execution section that performs processing related to the virtual machine or including a startup condition related to a startup status of another virtual machine. The processing includes starting up a virtual machine that has satisfied the startup condition based on the startup condition information.

The program recorded on the non-transitory recording medium of the seventh aspect causes the computer to start up the virtual machine that has satisfied the startup condition based on the startup condition information. This thereby enables the individual virtual machines to be started up with appropriate startup conditions.

The present disclosure enables individual virtual machines to be started up with appropriate startup conditions.

### BRIEF DESCRIPTION OF THE DRAWINGS

Exemplary embodiments of the present disclosure will be described in detail based on the following figures, wherein:

FIG. 1 is a diagram illustrating a vehicle installed with a central ECU according to an exemplary embodiment;

FIG. 2 is a block diagram illustrating a hardware configuration of a central ECU according to the exemplary embodiment;

FIG. 3 is a block diagram illustrating a schematic configuration of the central ECU according to the exemplary embodiment;

FIG. 4 is a functional block diagram illustrating functions of a hypervisor;

FIG. 5 is a diagram illustrating an example of startup condition information; and

FIG. 6 is a flowchart illustrating an example of flow of processing performed in a central ECU according to the exemplary embodiment when each VM is started up.

### DETAILED DESCRIPTION

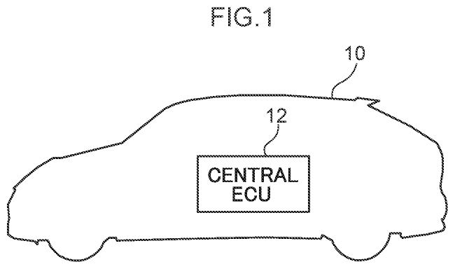

Detailed description follows regarding an example of an exemplary embodiment of the present disclosure, with reference to the drawings. A central ECU installed to a vehicle will be described as an example of an information processing device of the present exemplary embodiment. FIG. 1 is a diagram illustrating a vehicle installed with a central electronic control unit (ECU) according to the present exemplary embodiment.

The central ECU 12 according to the present exemplary embodiment is installed in a vehicle 10 and performs overall control of each ECU provided to the vehicle 10.

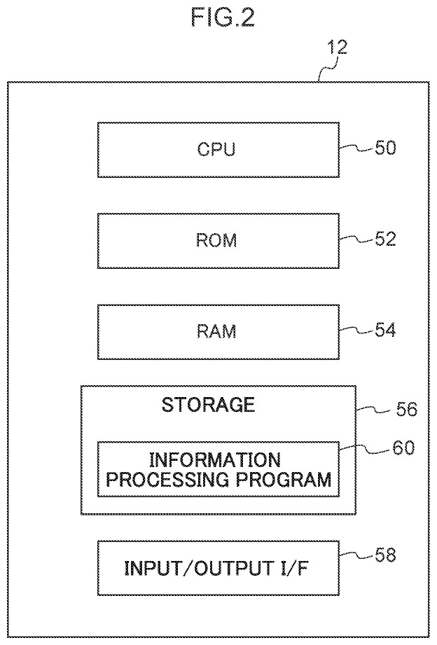

As illustrated in FIG. 2, the central ECU 12 is configured including a central processing unit (CPU) 50, read only memory (ROM) 52, random access memory (RAM) 54, storage 56, and an input/output interface (I/F) 58. The CPU 50, the ROM 52, the RAM 54, the storage 56, and the input/output I/F 58 are connected together so as to be able to communicate with each other through a non-illustrated internal bus. The CPU 50 is an example of a processor, and the RAM 54 is an example of memory.

The CPU 50 is a central processing unit that executes various programs and controls each section. Namely, the CPU 50 reads a program from the ROM 52 or the storage 56 and executes the program using the RAM 54 as workspace.

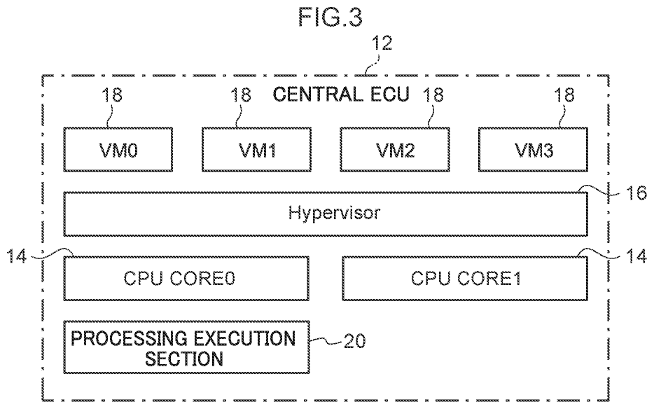

In the present exemplary embodiment, for example as illustrated in FIG. 3, there are plural CPU cores 14 present (i.e. two cores in the example of FIG. 3: CPU CORE 0 and CPU CORE 1).

The ROM 52 is stored with various programs and various data. The RAM 54 serves as workspace for temporarily storing programs and data.

The storage 56 is stored with various programs and various data. An information processing program 60 is stored in the storage 56 of the present exemplary embodiment.

The storage 56 is, for example, configured by a hard disk drive (HDD) or a solid state drive (SSD).

The input/output I/F 58 is an interface for performing communication with each of other ECUs (not illustrated in the drawings).

FIG. 3 is a block diagram illustrating a schematic configuration of the central ECU 12 according to the present exemplary embodiment.

In the present exemplary embodiment plural CPU cores 14 are virtualized and virtual machines (VM) 18 are generated as virtual machines by the hypervisor 16 that is software for virtualizing computers. In the present exemplary embodiment there are plural VMs 18 generated by the hypervisor 16. In the example illustrated in FIG. 3 four VMs 18 are generated as the plural VMs 18: VM0 to VM3. The plural VMs 18 include, for example, a multimedia VM, a body control VM, an engine control VM, and an automated driving control VM.

The central ECU 12 is equipped with a processing execution section 20 to perform processing related to the VMs 18. The processing execution section 20 performs, for example, detection processing related to security of each of the VMs 18.

Conditions related to startup of VMs are often not set in a system employing a general purpose hypervisor. However, when a hypervisor is introduced into an onboard system including plural VMs, as in the present exemplary embodiment, various startup conditions are conceivable, such as various startup triggers and startup inter-dependency relationships between VMs. There is accordingly a need for a design of VM startup to match the various startup conditions.

Thus in the central ECU 12 according to the present exemplary embodiment, at least one startup condition is determined for each of the VMs 18 and selected from the group consisting of a startup condition related to external interrupt, a startup condition related to a confirmation result of processing status of the processing execution section 20, and a startup condition related to startup status of another VM 18, and the VM 18 is started up when the at least one startup condition has been satisfied.

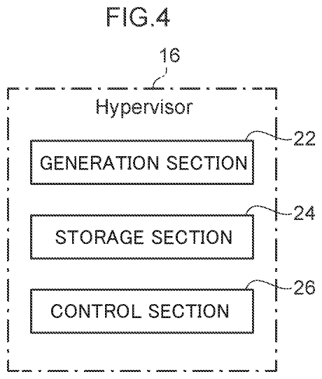

Description follows regarding a functional configuration of the hypervisor 16. FIG. 4 is a functional block diagram illustrating functions of the hypervisor 16.

The hypervisor 16 includes functions of a generation section 22, a storage section 24, and a control section 26 as illustrated in FIG. 4.

The generation section 22 generates plural VMs 18 with virtualized CPU cores 14. In the present exemplary embodiment there are, as stated above, four VMs 18 generated: VM0 to VM3.

The storage section 24 is stored with startup condition information of a startup condition determined for each of the plural VMs 18.

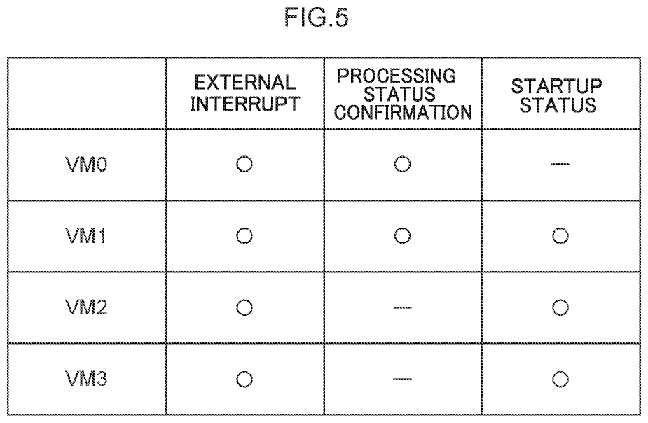

The startup condition information includes at least one startup condition determined for each of the VMs 18 and selected from the group consisting of the startup condition related to external interrupt, the startup condition related to the confirmation result of the processing status of the processing execution section 20, and the startup condition related to the startup status of another of the VMs 18 (FIG. 5).

FIG. 5 illustrates an example in which the startup condition related to external interrupt and the startup condition related to the confirmation result of processing status of the processing execution section 20 are determined for the VM0. FIG. 5 also illustrates an example in which the startup condition related to external interrupt, the startup condition related to the confirmation result of processing status of the processing execution section 20, and the startup condition related to startup status of another VM 18 are determined for the VM1. FIG. 5 also illustrates an example in which the startup condition related to external interrupt and the startup condition related to the startup status of another VM 18 are determined for the VM2 and VM3.

The startup condition related to external interrupt is, for example, a changed power state of the vehicle, such as the ignition switch (not illustrated in the drawings) being switched ON.

A startup condition related to the confirmation result of processing status of the processing execution section 20 is, for example, confirmation that detection processing related to security of a target VM 18 has been completed by the processing execution section 20. In the present exemplary embodiment the processing status of the processing execution section 20 is confirmed by the hypervisor 16 polling since an interruption is not able to be issued from the processing execution section 20.

The startup condition related to startup status of another VM 18 is, for example, that there was a notification of completion of initialization of a VM 18 having an inter-dependency relationship to the target VM 18. In the present exemplary embodiment, the other VMs 18 are not able to be initialized until startup of the VM0 that is the management VM managing the VMs 18 has completed. The other VMs 18 are accordingly determined to have as a dependency relationship a startup condition of a notification of initialization completion of the VM0 having been made.

When updating the startup condition information stored in the storage section 24, updating of the startup condition information is performed prior to detection processing by the processing execution section 20.

From out of the VMs 18, the control section 26 starts up the VMs 18 that have satisfied all of the respective determined startup conditions. More specifically, the control section 26 determines whether or not all of the determined startup conditions have been satisfied for each of the VMs 18 based on the startup condition information, and starts up the VMs 18 for which all the respective determined startup conditions have been satisfied.

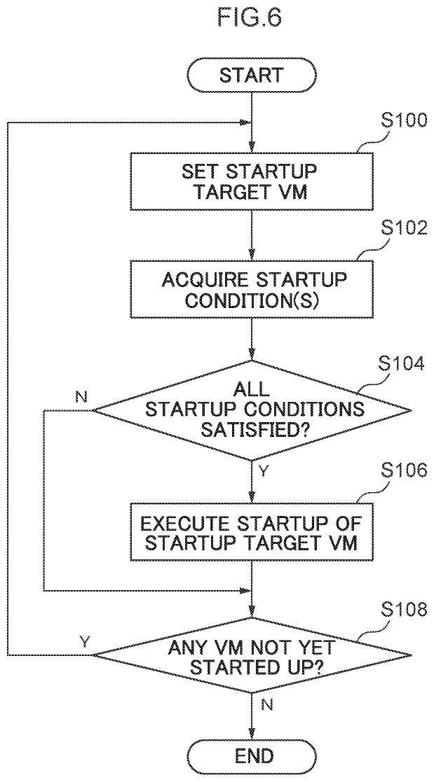

Next, explanation follows regarding specific processing performed by the central ECU 12 according to the present exemplary embodiment configured as described above. FIG. 6 is a flowchart illustrating an example of a flow of processing in the central ECU 12 according to the present exemplary embodiment performed when each of the VMs 18 is started up. Note that the processing of FIG. 6 is, for example, started when a door (not illustrated in the drawings) of the vehicle 10 has been unlocked.

At step S100 the CPU 22 acts as the hypervisor 16 and sets a startup target VM 18 from out of the VMs 18 not yet started up.

At step S102 the CPU 22 acts as the hypervisor 16 to acquire the startup conditions for the startup target VM 18 from the startup condition information.

At step S104 the CPU 22 acts as the hypervisor 16 to determine whether or not all of the startup conditions acquired at step S102 have been satisfied. The CPU 22 transitions to step S106 in cases in which all of the startup conditions have been satisfied for the startup target VM 18. The CPU 22 transitions to step S108 in cases in which not all of the startup conditions have been satisfied for the startup target VM 18.

At step S106 the CPU 22 acts as the hypervisor 16 and executes startup of the startup target VM 18.

At step S108 the CPU 22 acts as the hypervisor 16 and determines whether or not there is a VM 18 that has not yet started up present. Processing returns to step S100 in cases in which there is a VM 18 that has not yet started up, and such a VM 18 is set as the startup target VM 18. The cycle of processing is, however, ended in cases in which there is no VM 18 that has not yet started up.

Performing such processing enables startup conditions determined for each of the virtual machines to be set according to the processing execution section and the other virtual machines, enabling the virtual machines to be started up with appropriate individual startup conditions. Moreover, a combination of at least one startup condition can be set for each of the virtual machines.

Moreover, a central ECU installed in a vehicle can set appropriate startup conditions for generating various VMs individually for the various VMs.

Note that although in the exemplary embodiment described above an example has been described of a case in which there are two CPU cores 14 provided, there is no limitation thereto. For example, an embodiment may be adopted in which there is a single CPU core 14 provided, and an embodiment may be adopted in which there are three or more CPU cores 14 provided.

Moreover, although an example has been described in the above exemplary embodiment in which the hypervisor 16 generates four VMs 18, there is no limitation thereto. For example, three or less VMs 18 may be generated or five or more VMs 18 may be generated.

Although in the exemplary embodiment described above an example has been described of a case in which the vehicle 10 is a vehicle driven by operating a gasoline engine as motive force there is no limitation thereto. The vehicle 10 may be an electric vehicle such as a hybrid electric vehicle (HEV), a plug-in hybrid electric vehicle (PHEV), a fuel cell electric vehicle (FCEV), or a battery electric vehicle (BEV).

Moreover, the various processing executed by the CPU 22 reading software (a program) in the above exemplary embodiment may be executed by various processors other than a CPU. Examples of such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Moreover, the processing described above may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, in the exemplary embodiment described above an embodiment has been described in which a program is pre-stored (installed) on a non-transitory computer readable recording medium. However, the information processing program 60 may, for example, be pre-stored on the ROM 52. However, there is no limitation thereto, and the information processing program 60 may be provided in a format recorded on a non-transitory recording medium such as a compact disc read only memory (CD-ROM), digital versatile disc read only memory (DVD-ROM), universal serial bus (USB) memory, or the like. The information processing program 60 may also be in a format downloadable from an external device over a network.

In the flow of processing described for the present exemplary embodiment, for example, redundant steps may be omitted, new steps may be added, and the processing sequence may be swapped around within a range not departing from the spirit of the present disclosure.

What is claimed is:

1. An information processing device comprising:
memory configured to store startup condition information determined for each virtual machine of a plurality of virtual machines, and including a startup condition related to a confirmation result of processing status of a processing execution section that performs processing related to the virtual machine or including a startup condition related to a startup status of another virtual machine; and
a processor coupled to the memory, wherein
the processor is configured to startup a virtual machine that has satisfied the startup condition, based on the startup condition information.

2. The information processing device of claim 1, wherein:
the startup condition information determined for each virtual machine of the plurality of virtual machines includes at least one startup condition selected from the group consisting of a startup condition related to external interrupt, the startup condition related to the confirmation result of the processing status, and the startup condition related to the startup status of the other virtual machine; and
the processor is configured to start up a virtual machine that has satisfied all of the at least one startup condition.

3. The information processing device of claim 1, wherein the other virtual machine is a virtual machine that manages the plurality of virtual machines.

4. The information processing device of claim 1, wherein an update of the startup condition information stored in the memory is performed prior to processing of the processing execution section.

5. A vehicle comprising the information processing device of claim 1.

6. An information processing method comprising:
a computer, which includes memory configured to store startup condition information determined for each virtual machine of a plurality of virtual machines, and including a startup condition related to a confirmation result of processing status of a processing execution section that performs processing related to the virtual machine or including a startup condition related to a startup status of another virtual machine, starting up a virtual machine that has satisfied the startup condition, based on the startup condition information.

7. A non-transitory recording medium storing a program that is executable by a computer to perform processing wherein:
the computer comprises memory configured to store startup condition information determined for each virtual machine of a plurality of virtual machines, and including a startup condition related to a confirmation result of processing status of a processing execution section that performs processing related to the virtual machine or including a startup condition related to a startup status of another virtual machine; and
the processing comprises starting up a virtual machine that has satisfied the startup condition, based on the startup condition information.
